(19) United States
(12) Patent Application Publication
(10) Pub. No.: US 2004/0186764 A1
(43) Pub. Date: Sep. 23, 2004

(54) Method and system for evaluating business service relationships

(76) Inventor: Kevin M. McNeill, Tucson, AZ (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/389,763

(22) Filed: Mar. 18, 2003

(51) Int. Cl. G06F 17/60

(52) U.S. Cl. 705/10

(57) ABSTRACT

A method and system for evaluating a business service relationship model for a business organization, the business service relationship model including a plurality of business service entities (BSEs) and at least one service relationship vector (SRV), each of the at least one SRV defining a business relationship between two BSEs in the plurality of BSEs. The method comprises (1) storing respective attribute information for the plurality of BSEs; (2) storing respective attribute information for the at least one SRV; (3) simulating the business service relationship model over a simulation time period using the stored BSE attribute information and the stored SRV attribute information; and (4) displaying results of the simulating step in order to evaluate the business service relationship model. The business service relationship model is simulated using an event-driven, object-oriented methodology.

### BACKGROUND OF THE INVENTION

1. Field of the Invention

The present invention relates generally to methods and systems for evaluating, analyzing, and modeling business service relationships.

The present invention includes the use of various technologies referenced and described in the references identified in the following LIST OF REFERENCES by the author(s) and year of publication and cross-referenced throughout the specification by reference to the respective number in parentheses, of the reference:

### LIST OF REFERENCES

[1] D. Neal, H. Smith, and D. Butler, “The evolution of business processes from description to data to smart executable code is this the future of systems integration and collaborative commerce?” Computer Sciences Corporation, Foundation Library (available at www.cscresearchservice.com/foundation/library).

[2] J. Baker and I. Ghalimi, “BPML 101: Implementing the BPML Specification” (available at BPMI.org).

[3] A. Arkin, “Business Process Modeling Language,” 1992 (available at BPMI.org).

[4] S. E. White, “Business Process Modeling Notation, 1992, (available at BPMI.org).

[5] R. E. Johnson, “Dynamic Object Model,” University of Illinois at Urbana-Champaign (available at st-www.cs.uiuc.edu/users/johnson/papers).

[6] R. E. Johnson and J. Oakes, “The user-defined product framework,” unpublished paper by Ralph E. Johnson and Jeff Oakes, Department of Computer Science, University of Illinois at Urbana-Champaign (available at st-www.cs.uiuc.edu/users/johnson/papers).

[7] Martin Modell, A Professional's Guide to Systems Analysis, 2^{nd} Edition, McGraw-Hill, New York, N.Y., 1996.

[8] B. Curtis, M. Kellner, and J. Over, “Process Modeling”, Communications of the ACM, September 1992, Vol. 35, No.9.

[9] Eriksson, Hans-Erik and Penker, Magnus: “Business Modeling with UML: Business Patterns at Work”, Wiley & Sons, 1999.

The entire contents of each reference listed in the LIST OF REFERENCES are incorporated herein by reference.

2. Discussion of the Background

Several business modeling techniques have been the subject of research in the past decades. Two of these, the classical approach and “business process modeling,” are widely used in simulation environments to provide projective estimates for different metrics in the business cycle.

The classical approach to business modeling aims at capturing the cause and effect chain across different organizational entities. This functional approach is lacking in its ability to capture the nature of the relationships that govern the rich interactions across different business units. It lacks robustness and is unable to properly represent the dynamics of business logic. In effect, simulations based on a purely functional approach tend to provide results with a significant margin of error. Many classes of simulators have been developed using this approach, including (1) flow-chart-based tools, which strictly follow the classical approach, and (2) system-dynamics-based tools, which adopt a more structured approach to the classical model [7][8].

A newer approach in business modeling called “business process modeling” defines business as a set of activities called processes [1-6]. Processes decouple themselves from strict structured approaches (e.g., layering) as processes can cut through the boundaries of whole organizational planes. It is widely believed in the business community that these models are more accurate than their classical counterparts, and are capable of capturing the realism in business logic. These types of simulators are often referred to as “Discrete-Event Based Tools,” and are object-oriented in nature.

There are newer implementations of process modeling that are essentially the same as the older approaches, but are wrapped in newer Extensible Markup Language (XML)-based syntax. For example, Business Process Modeling Language (BPML) [1-4] is XML based and includes a graphical notation. However, the focus of BMPL is on business processes, rather than business relationships. Moreover, BPML and its associated graphical notation do not support a simulation engine.

Other approaches that are object-oriented include the Rational Rose tools [9] for modeling Business Processes that use and extend the UML (Uniform Modeling Language), which were developed by the software development community. Although UML lacks the concept of a service relationship, UML describes classical object-oriented relationships (e.g., association, dependency, inheritance, instantiation, generalization, and aggregation). For example, Rational uses a set of graphical representations to capture static and dynamic aspects of the behavior of systems. Again however, there is no simulation component and the tool is used for knowledge management and requirements analysis for developing software systems to support business processes or for business process re-engineering.

Other business process management systems are designed to integrate business workflows into an automated system. See, e.g., U.S. Pat. Nos. 6,073,109; 5,535,389; and 5,630,069. However, these models fail to address the analysis and simulation of a plurality of alternative business models or a methodology to provide managers with simulation data allowing them to select between alternative business models.

### SUMMARY OF THE INVENTION

Accordingly, an object of the present invention is to provide a method, system, and computer program product for accurately evaluating and analyzing business service relationships.

Another objective of the present invention is to provide to provide business managers with simulation data that allows them to select between alternative business service relationship models. Included in this objective is the capability to interface a simulation with real-world business systems to allow simulation results to directly drive external business systems or to allow real-world data from external business systems to influence the simulated business service relationships.

To address the above and other objectives, the present invention provides a method, system, and computer program product for evaluating a business service relationship model for a business organization, the business service relationship model comprising a plurality of business service entities (BSEs) and at least one service relationship vector (SRV), each of the at least one SRV defining a business relationship between two BSEs in the plurality of BSEs, the method comprising: (1) storing respective attribute information for the plurality of BSEs; (2) storing respective attribute information for the at least one SRV; (3) simulating the business service relationship model over a simulation time period using the stored BSE attribute information and the stored SRV attribute information; and (4) displaying results of the simulating step in order to evaluate the business service relationship model.

According to another aspect of the present invention, the method further comprises (1) storing respective attribute information for at least one service domain; (2) defining at least one business process (BP) associated with a respective BSE in the plurality of BSEs; and (3) storing respective attribute information for the at least one BP.

According to one aspect of the present invention, the step of storing respective attribute information for the plurality of BSEs comprises storing respective attribute information associated with providing one of a good and a service, including start-up cost, revenue of service, start-up revenue, service interval length, and service period, for each of the plurality of BSEs.

According to another aspect of the present invention, the step of storing respective attribute information for the plurality of BSEs comprises storing, for each BSE in the plurality of BSEs, respective attribute information indicating whether the BSE is an interior business entity of the business organization.

According to a further aspect of the present invention, the step of storing respective attribute information for the at least one SRV comprises: (1) identifying at least one pair of BSEs in the plurality of BSEs; and (2) storing respective attribute information indicating one of a service-value, service-service, goods-value, and goods-service business relationship between each identified pair of BSEs.

In addition, according to still another aspect of the present invention, the step of storing respective attribute information for the at least one SRV comprises storing respective attribute information associated with a contract for one of goods and a service, including contract type, contract start date, contract end date, initial cost, termination cost, recurring cost, initial revenue, contract period, and contract period type.

In addition, according to another aspect of the present invention, the simulating step comprises: (1) setting simulation parameters including a simulation start time, a simulation end time, the simulation time period, the simulation output method, and a simulation update interval; and (2) calculating an income, a cost, and a profit for each of the plurality of BSEs for at least one simulation update interval.

In addition, according to still another aspect of the present invention, the displaying step comprises providing information to an end-user including a value of the business service relationship model by sending the results of the simulating step to an output manager, the results being formatted by the output manager according to the simulation output method.

In addition, according to still another aspect of the present invention, the method further comprises: (1) creating a mapping between the stored BSE attribute information, the stored SRV attribute information, the stored BP attribute information, and corresponding data variables in an external real-world system; (2) directing the output manager to send the results of the simulating step to the external real-world system through a real-world gateway during the simulation time period; (3) receiving input information from the external real-world system through the real-world gateway during the simulation time period; and (3) directing the input information to the at least one BP.

Note that the system of the present invention expands on simple process modeling by including the dynamics of business relationships, and adding the concept of non-hierarchical Service Domains to give the model more power in simulating multi-organizational business relationships.

### BRIEF DESCRIPTION OF THE DRAWINGS

A more complete appreciation of the invention and many of the attendant advantages thereof will be readily obtained as the same becomes better understood by reference to the following detailed description, when considered in connection with the accompanying drawings, wherein:

FIG. 1 illustrates a simple example of modeling business service relationships in the specific context of radiology image archiving services using the method of the present invention;

FIG. 2 illustrates the steps in the method of evaluating a business service relationship plan according to the present invention;

FIG. 3 illustrates four specializations (subclasses) of business service relationships capturing different modes of business interactions according to the present invention;

FIG. 4A illustrates the relationship between BSE and Service Domain objects according to an object-oriented implementation of the present invention;

FIG. 4B illustrates the relationship between BSE and SRV object classes (and associated dialog objects) in an object-oriented implementation of the present invention;

FIG. 5 illustrates the relationship between Event, Business Process, Output Manger, and Simulation Dialog classes according to an object-oriented implementation of the present invention;

FIG. 6 shows the top-level BSRMsim dialog box;

FIG. 7 shows the Create BSE dialog box;

FIG. 8 shows the Edit BSE Relationship dialog box used to create/edit an SRV;

FIG. 9 shows a Simulation Run dialog box in which BSRMsim simulation parameters are set; and

FIG. 10 shows an example of simulation output according to the present invention.

### DESCRIPTION OF THE PREFERRED EMBODIMENTS

The present invention is based on a business service relationship model (hereinafter “BSRM”), which is an object-oriented analytical model that supports the analysis, design, and implementation of business relationships, including the evaluation of alternative relationship structures that implement different business plans. BSRM can model any type of business service, allowing an organization to plan and evaluate potential services and relationships between services, and to select among multiple options for the delivery of end-user (or customer) services. The model allows a business organization using BSRM to model and analyze services according to distinct domains of services; organize specific service functions into distinct service entities; model the relationship between each pair of service entities; and to distinguish between service entities that exist within the organization that is being modeled and those that exist as part of external organizations. The last feature allows distinction within the model between “in-house” entities and “out-sourced” entities. Each of these features of the model is captured as an object that can be implemented in a software simulation model. The simulation model can be executed to simulate the business relationships under analysis.

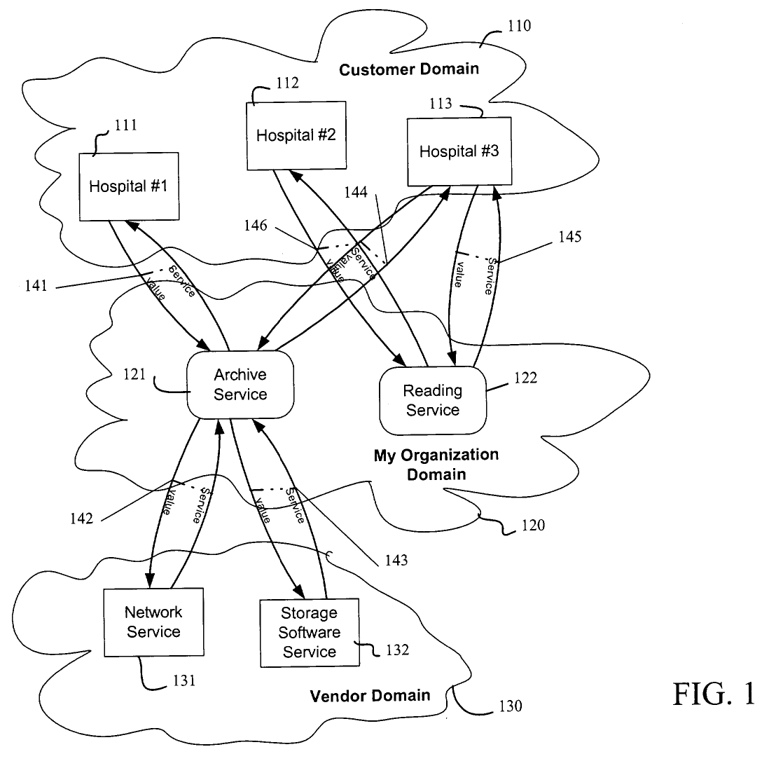

Referring now to the drawings, wherein like reference numerals designate identical or corresponding parts throughout the several views, and more particularly to FIG. 1 thereof, there is illustrated a simple example of modeling business service relationships using BSRM in the specific context of radiology image archiving services. In FIG. 1, seven business service entities (BSEs) are grouped in to three service domains: (1) a customer domain 110 including Hospital#1 111, Hospital#2 112, and Hospital#3 113; (2) a vendor domain 130 including Network Service 131 and Storage Software Service 132; and (3) the organization domain 120, which includes an archive service 121 and a reading service 122. In addition, FIG. 1 shows six Service Relationship Vectors (SRVs) 141-146 that capture the business relationships between various pairs of the seven business entities illustrated. For example, SRV 141 describes a one-year contract between Hospital# 1 111 and Archive Service 121. In this business relationship, the Archive Service 121 agrees to archive at least 10,000 cases in exchange for an initiation fee of $1,000, and a storage fee of $2.50 per case per month, billed monthly. The attribute/parameter information associated with BSEs and SRVs is discussed in more detail below.

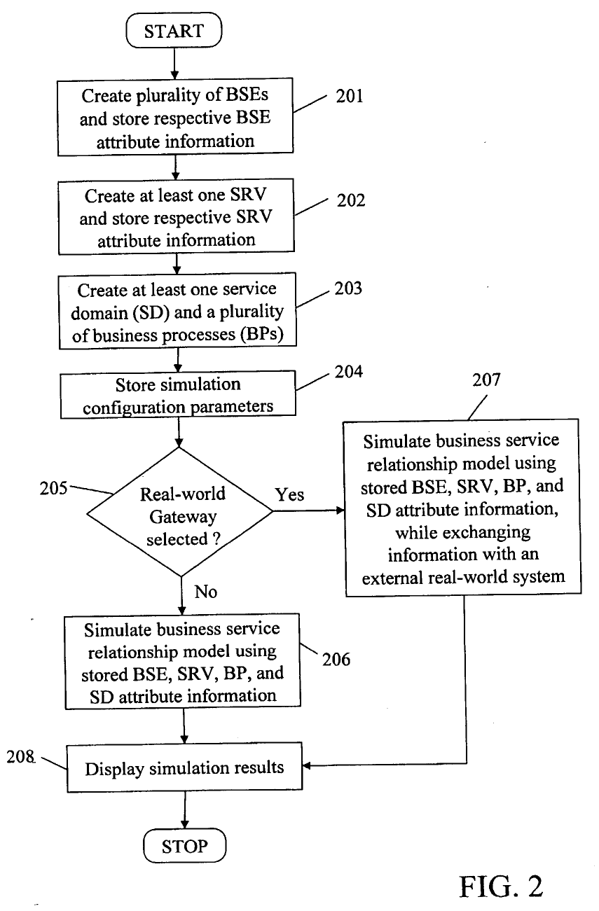

FIG. 2 shows the steps in a method of evaluating a business service relationship model for a business organization in which the business service relationship model include a plurality of business service entities (BSEs) and at least one service relationship vector (SRV), as illustrated, e.g., in FIG. 1. As will be discussed in more detail below, each SRV defines a business relationship between two BSEs.

In step 201, a plurality of BSEs are created and respective attribute information is set and stored for each of the BSEs. In particular, as discussed below, BSE attributes may include start-up cost, revenue of service, start-up revenue, service interval length, and service period. In addition, as discussed below, attribute information indicating whether a given BSE is an interior or exterior business entity is also stored. As shown in FIG. 1, examples of BSEs include a hospital, a communication service provider, a data storage service provider, an archive service, and a reading service provider.

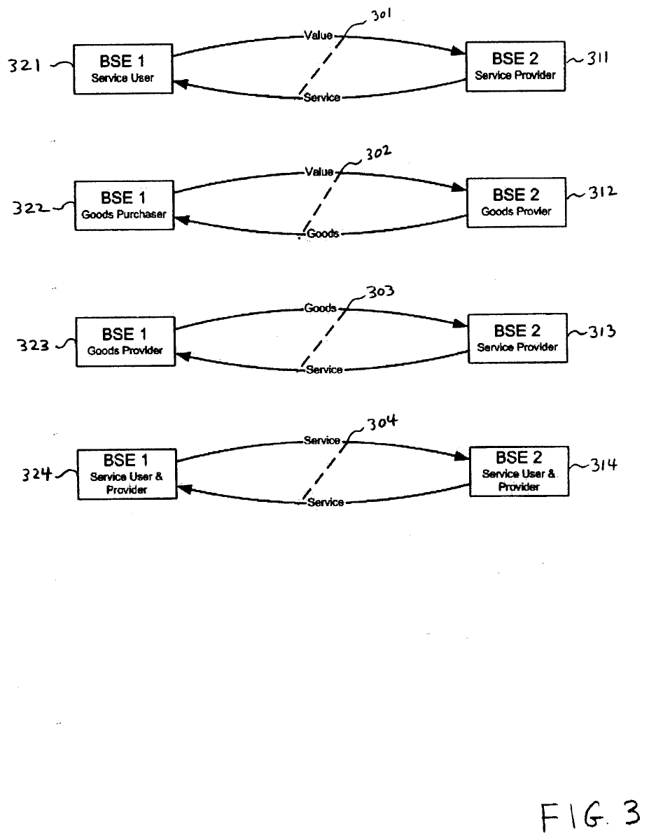

In step 202, at least one SRV is created and respective attribute information is set and stored for each SRV. Step 202 includes identifying pairs of BSEs in the plurality of BSEs and storing respective attribute information for each SRV, indicating, for example, one of a service-value, service-service, goods-value, and goods-service business relationship between each identified pair of BSEs. See the description of FIG. 3 for more details regarding the four types of SRVs. In addition, as discussed in more detail below, SRV attribute information includes information associated with a contract for goods or a service, including contract type, contract start date, contract end date, initial cost, termination cost, recurring cost, initial revenue, contract period, and contract period type. In one computer-implemented embodiment of the present invention, the relationship chart of FIG. 1 is displayed and BSE and SRV attribute information can be modified by mouse clicking on the appropriate object.

In step 203, at least one service domain (SD) and a plurality of business processes (BPs) are created and corresponding attribute information stored. At least one business process is created for each BSE, as is described in more detail below.

In step 204, simulation parameters including a simulation start time, a simulation end time, a simulation time period, and a simulation update interval are set and stored. In addition, output parameters, such as those related to a Real-World Gateway are also set and stored in step 204. Output attributes, including those associated with an Output Manager, are discussed in more detail below.

In step 205, an inquiry is made as to whether the Output Manager (discussed below) is configured to send and receive information through a Real-World Gateway. If not, the method proceeds to step 206. If the answer to the inquiry of step 205 is yes, the method proceeds to step 207.

In step 206, the business service relationship model is simulated over the simulation time period using the BSE attribute information, the SRV attribute information, the BP attribute information, and the SD attribute information stored in steps 201-203.

In step 207, if the Output Manager is configured to send and receive information through the Real World Gateway, attribute information is exchanged with an external real-world system while the business service relationship model is simulated over the simulation time period using the BSE attribute information, the SRV attribute information, the BP attribute information, and the SD attribute information stored in steps 201-203. In particular, input information from the external real-world system may be used by the plurality of BPs in updating attribute information of corresponding BSEs.

In step 208, results of the simulation are displayed in an appropriate format in order to evaluate the business service relationship model.

BSRM Objects

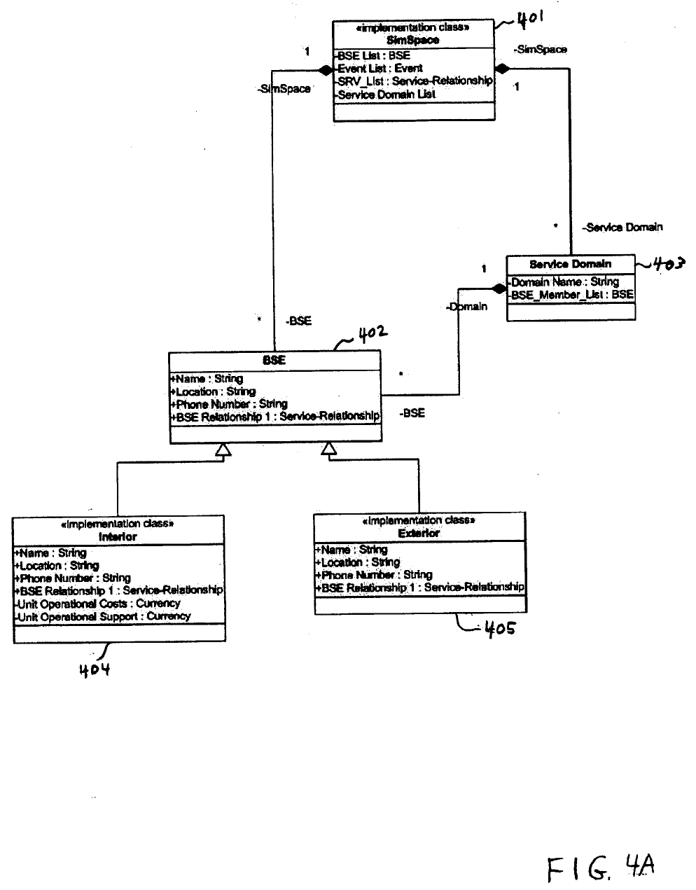

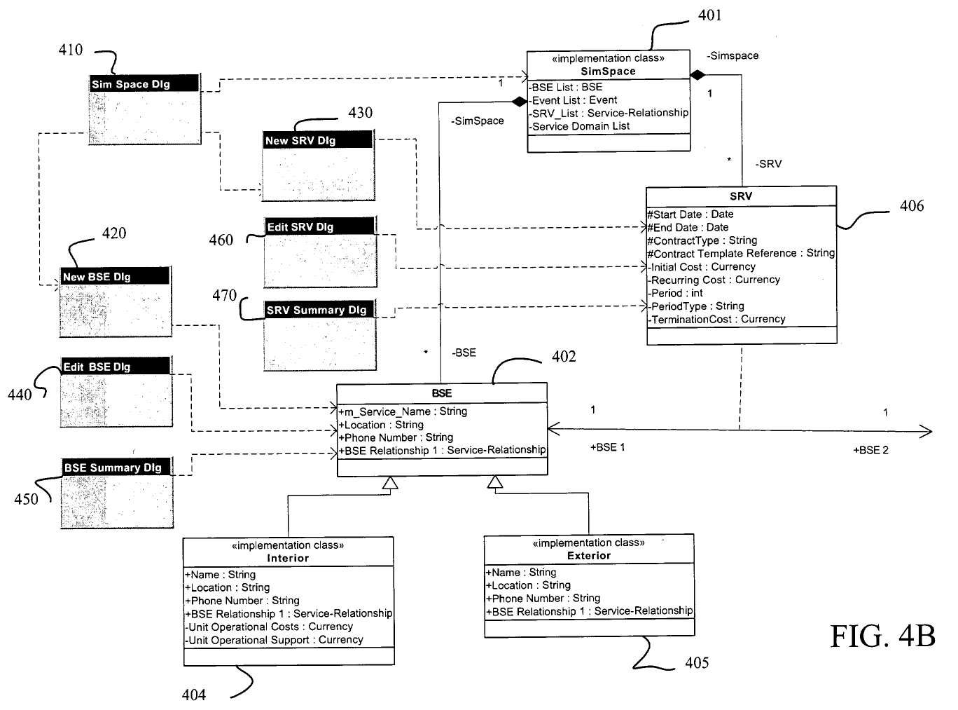

BSRM defines specific business processes or business functions as objects according to the requirements of the business model under analysis. Moreover, BSRM defines object classes according to the principles of object-oriented software design, since the present invention is preferably implemented as an object-oriented computer program product. For example, BSRM defines an object called a “SimSpace” that is a container for a specific business model/plan simulation. See FIGS. 4A and 4B. All other objects in the BSRM are contained within the SimSpace object and this object is used to serialize an active simulation run for archiving purposes. BSRM defines a set of list objects contained in the SimSpace object. These lists are used to hold other objects as they are created during a simulation of a business process.

Business Service Entity (BSEs) Class

BSRM defines a generic class of objects called Business Service Entities (BSEs). Each BSE object implemented in the model has a common set of attributes, a common set of behaviors, and a unique identity. In addition, BSRM defines two specializations (subclasses) of BSE objects that further specify additional details of the service entity. The two classes are “Interior” and “Exterior.” From the perspective of the organization being analyzed under this technique, an “Interior” BSE object represents a service entity that is a part of the organization, while an “Exterior” BSE object represents a service entity that is not a part of the organization. Further, BSRM allows additional refinement of the model through the use of additional sub-specialization of BSE subclasses to add attributes.

In one embodiment, the simulation software implementing the present invention performs a simple calculation for each BSE at each cycle of the simulation. An Event object (discussed below) associated with the BSE is activated and calculates a simple sum of the “costs” and “revenues” associated with the BSE. This method produces a “bottom line” value for the BSE. In addition, as discussed below, more detailed categories of costs can be selected by the user. For example, cost categories such as personnel, capital, operations, etc. can be accounted for in the model. These cost categories can be tied to more sophisticated Business Process objects (discussed below) to model dynamic aspects of the business. For example, if a BSE must add personnel to accommodate growth in customers, the Business Process object can capture that requirement and send a message to the BSE object specifying that personnel costs increase.

In one embodiment, BSE attributes include:

C_{base}=Startup (one-time) contribution to base cost of entity;

C_{base}(t)=Base cost of entity as function of time (recurring);

C_{Oper}(t)=Operational costs as function of time, which are calculated by adding up the costs associated with all relationships in which the BSE participates (from SRV objects);

S_{base}=Startup (non-recurring) support of BSE; represents non-relationship derived one-time base funding for the BSE;

S_{base}(t)=Operational (recurring) base funding of BSE; represents non-relationship derived base funding for the BSE;

R_{Start}=Startup (one-time) revenue for the BSE, which is the sum of all Rvstart values for each SRV in which the BSE participates; and

R_{Oper}(t)=Operational (recurring) revenue for the BSE, which is the sum of all R^{V}_{Oper}(t) values for each SRV in which the BSE participates.

In general, separate attributes capture both non-recurring costs or revenues, and recurring costs or revenues. This gives BSRM a mechanism to distinguish between one-time costs and on-going costs. Using the attributes associated with the BSE, BSRM can represent costs and revenues specific to each instance of a BSE that is defined in the model. For a BSE, these costs capture a base one-time startup cost (e.g., the one time costs to create a new business entity), base recurring cost whether the BSE is operational or not, and base recurring cost for the BSE to conduct operations. The operational costs are related to the SRVs in which the BSE participates, and are calculated from attributes associated with the SRV. These components can be combined to model the cost of the BSE.

For the BSE, BSRM also models “support” both non-recurring and recurring. This represents financial support or cost offsets to represent for example, the cross subsidizing of business units within an organization or other types of non-revenue sources of financial support for the BSE. Finally, revenue associated with each BSE can be modeled. Again, BSRM provides the capability to capture non-recurring and recurring revenue. Revenue is modeled as dependent on relationships (via SRVs). Therefore, both the recurring and non-recurring revenues for each BSE are calculated from attributes of the SRVs in which the BSE participates.

Business Process (BP) Class

BSRM defines “Business Process” (BP) objects that capture essential elements of a business process that is event driven. BPs are linked to specific Events, which are described in more detail below. The idea behind BPs is to provide a high degree of customizable business intelligence into the BSRM model. In one embodiment, a fixed set of generic subclasses are defined for the BP objects. Each generic subclass implements a generalized business process, with the capability for adjusting parameters. For example, a user selects from the list of predefined processes and then provides some level of customization. In a second embodiment, simple specification syntax is defined for the business processes, which allows the end-user to define totally customized BPs.

Service Domain (SD) Class

BSRM also defines a non-hierarchical “Service Domain” object, which is a container object that is used to organize BSE objects into domains in which all of the BSEs perform a similar type of process or function. See FIG. 1. BSRM defines the relationship between domains as an aggregate of the relationships between BSEs in different domains (i.e., those that cross domain boundaries). Thus, BSRM enables coarse modeling of a business model by analyzing at the Service Domain level. In addition, BSRM enables fine modeling of a business model by analyzing at the BSE level.

Service Relationship Vector (SRV) Class

BSRM defines a generic class of objects called a Service Relationship Vector (SRV). SRVs are a class of objects that capture the essential information about the business relationship between two BSEs. For example, in a typically relationship, the SRV may model a contract between two business service entities. The SRV is not intended to include the complete detail of the real-world contract, but only the essential parameters necessary for simulation of the business relationship and evaluation of alternative relationships.

As shown in FIG. 3, BSRM defines four specializations (subclasses) of SRVs that capture different modes of business interactions: (1) Service-Value SRV 301, (2) Goods-Value SRV 302, (3) Goods-Service SRV 303, and (4) Service-Service SRV 304.

BSRM defines the Service-Value SRV 301 to capture a relationship in which one BSE 311 provides a service to another BSE 321 in return for value (payment). BSRM defines the minimal generic attributes of a Service-Value SRV 301 as the following vector: <Service Vector: <definition, term, volume, non-recurring cost, recurring cost, interval>; Value Vector: <definition, non-recurring revenue, recurring revenue, interval>>.

BSRM defines the Goods-Value SRV 302 to capture a relationship in which one BSE 312 provides goods to another BSE 322 in return for value (payment). BSRM defines the minimal generic attributes of a Goods-Value SRV 302 as the following vector: <Goods Vector 1: <order reference, terms, non-recurring cost, recurring cost, interval>; Value Vector: <definition, non-recurring revenue, recurring revenue, interval>>.

BSRM defines the Goods-Service SRV 303 to capture a relationship in which one BSE 323 provides goods to another BSE 313 in return for a service. BSRM defines the minimal generic attributes of a Goods-Service SRV 303 as the following vector: <Goods Vector 1: <order reference, terms, non-recurring cost, recurring cost, interval>; Service Vector: <definition, term, volume, non-recurring cost, recurring cost, interval>>.

BSRM defines the Service-Service SRV 304 to capture a relationship in which one BSE 314 provides a service to another BSE 324 in return for a service. BSRM defines the minimal generic attributes of a Service-Service SRV 304 as the following vector: <Service Vector 1: <definition, term, volume, non-recurring cost, recurring cost, interval>; Service Vector 2: <definition, term, volume, non-recurring cost, recurring cost, interval>>.

For example, as shown in FIG. 1, Service-Value SRV 141 is given by <Service Vector: <Image Archive Service, 1 year contract with option to renew, volume {min 10,000 cases}, Start-up cost; $1,000, Recurring cost (e.g., maintenance & depreciation assignable to this customer), Period: Monthly>; Value Vector: <Fee per study stored, Start-up revenue: $1,000 initiation fee, Recurring revenue ($2.50 per study stored), Billing Interval: Monthly>>.

In modeling service relationships between business entities, BSRM uses attributes for each SRV to capture costs and revenues. Similar to the approach with BSEs, BSRM models both non-recurring and recurring costs associated with the relationship. Since relationships are bi-directional, there are four attributes to capture two classes of costs for each end of the SRV relationship vector. BSRM also models revenue, again both recurring and non-recurring, but the method assumes (for Service-Value) vectors that the revenue applies to the Service Provider side of the vector.

In one embodiment, attributes of a SRV include:

C^{V}ₛₜₐᵣₜ=Startup (one-time) cost of relationship to Service-Provider-side Entity;

C^{V}_{Oper}(t)=Operational (recurring) cost of relationship to Service-Provider-side Entity;

C^{S}_{Start}=Startup (one-time) cost of relationship to Service-User-side Entity;

C^{S}_{Oper}(t)=Operational (recurring) cost of relationship to Service-User-side Entity;

R^{V}_{Start}=Startup (one-time) revenue to Service-Provider-Side Entity and is usually equal to C^{S}_{Start}, but may be adjusted by a coefficient; and

R^{V}_{Oper}(t)=Operational (recurring) revenue to Service Provider Side Entity and is usually equal to C^{S}_{Oper}(t), but may be adjusted by a coefficient.

BSRM allows further refinement of specialized SRVs through additional sub-specialization in which additional attributes are added to capture additional refinement.

Event and Clock Object Classes

BSRM defines a class of objects called “Events.” Each Event object in the model corresponds to a time-based attribute of a BSE or a SRV object. In addition, BSRM defines a list object within the SimSpace object that is used to organize Events.

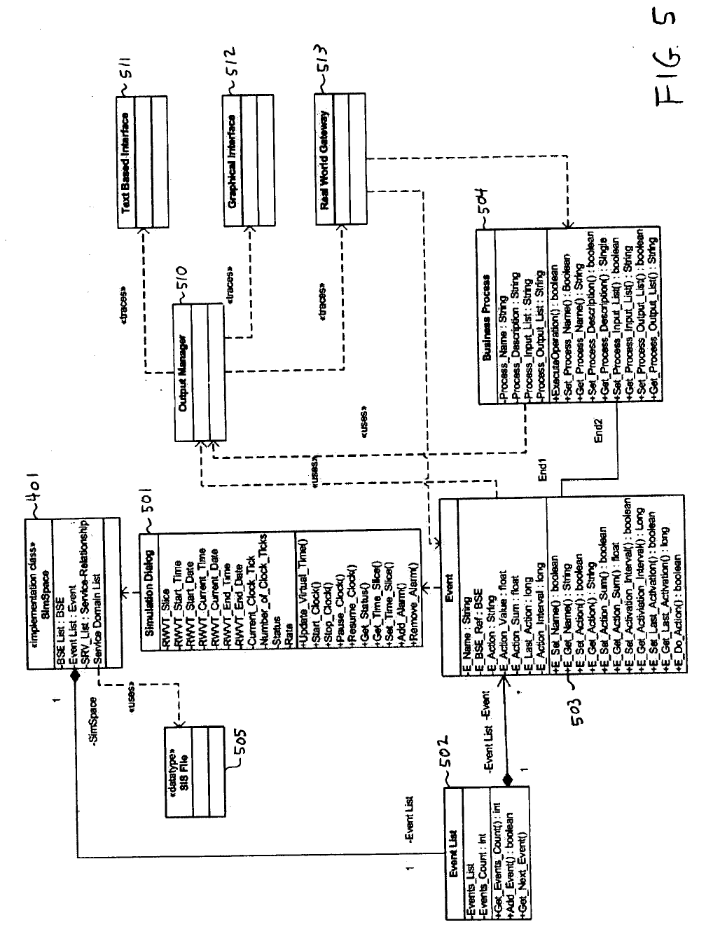

BSRM defines a “Clock” object that governs a simulation run. The Clock object specifies time “ticks” and bounds for a simulation run and controls the execution of Events during a simulation run. Thus, BSRM defines a simulation run as a sequential incrementing of the Clock object. At each click the Event list is scanned. For each Event, the interval parameter is checked against the change in the clock to determine if the Event is eligible for action. Eligible Events have their Business Process object executed to simulate the appropriate business activity. When the Event list is exhausted one cycle of the simulation is complete. See FIG. 5.

BSRM Graphical Representation

BSRM defines a graphical short-hand for drawing business models. In this short-hand, Exterior BSEs are represented as rectangles with sharp corners with the BSE name in the center. Interior BSEs are represented as rectangles with rounded corners. SRVs are represented as a pair of directed arcs with a dashed line linking the arcs and the relationship name in the center of the pair of arcs. The arrows of the arcs point in opposite directions indicating the bidirectional relationship between the entities. Service Domains are indicated as irregular clouds enclosing the BSEs included in the domain.

A Business Model Diagram is a hierarchy of three types of diagrams. The Overview Diagram is a graphical diagram with limited detail intended to capture BSEs and their relationships in a large scale at the level of BSEs. A Domain Diagram is similar, but captures the model at the Domain level without illustrating individual BSEs. SRV Detail Diagrams capture the details of a relationship between a pair of BSEs. The relationship is illustrated as described above for the Overview Diagrams. However, the arcs are decorated with additional detail text. Business Process Diagrams are a set of diagrams illustrating the business processes of individual BSEs. These are generic place-holder diagrams, and the content can follow any standard notation, with the default notation being UML (Uniform Modeling Language). This allows specific users of BSRM to use a notation most appropriate for their situation. Hence, it can be BPML, UML, or traditional flow-charts.

FIG. 4A illustrates the relationship between BSE and Service Domain objects in an object-oriented implementation of the present invention. In FIG. 4A, a SimSpace object 401, which is connected to BSE 402 and Service domain 403, includes a BSE list, an Event list, an SRV list, and a Service Domain list. In addition, FIG. 4A shows the relationship between the BSE 402 and its subclass objects, the Interior BSE object 404, and the Exterior BSE object 405.

FIG. 4B illustrates the relationship in one embodiment of the present invention between a SimSpace object 401, a BSE object 402, and a SRV object 406, and various dialog objects used to gather attributes of the SimSpace object 401, the BSE object 402, and the SRV object 406. For example, the New BSE Dialog 420, the Edit BSE Dialog 440, and the BSE Summary Dialog 450 provide attributes of the BSE 402. Similarly, the New SRV Dialog 430, the Edit SRV Dialog 460, and the SRV Summary Dialog 470 provide attributes of the SRV 406. The SimSpace Dialog 410 provides attributes of the SimSpace object 401. Further details of the dialog objects used in the simulation of BSRM are described below.

BSRM Output Objects

BSRM defines an object called an Output Manager. The responsibility of the Output Manager object, in a simulation run, is to manage the flow of simulation results and route them to one of three output interface objects. The output interface objects are Text-Based Interface, Graphical Interface, and Real-World Gateway Object.

BSRM defines the Text-Based Interface as any formatted text (e.g., a spreadsheet) output stream. The formatting of this stream is controlled by the Text-Based Interface object, which may be specialized for different output needs.

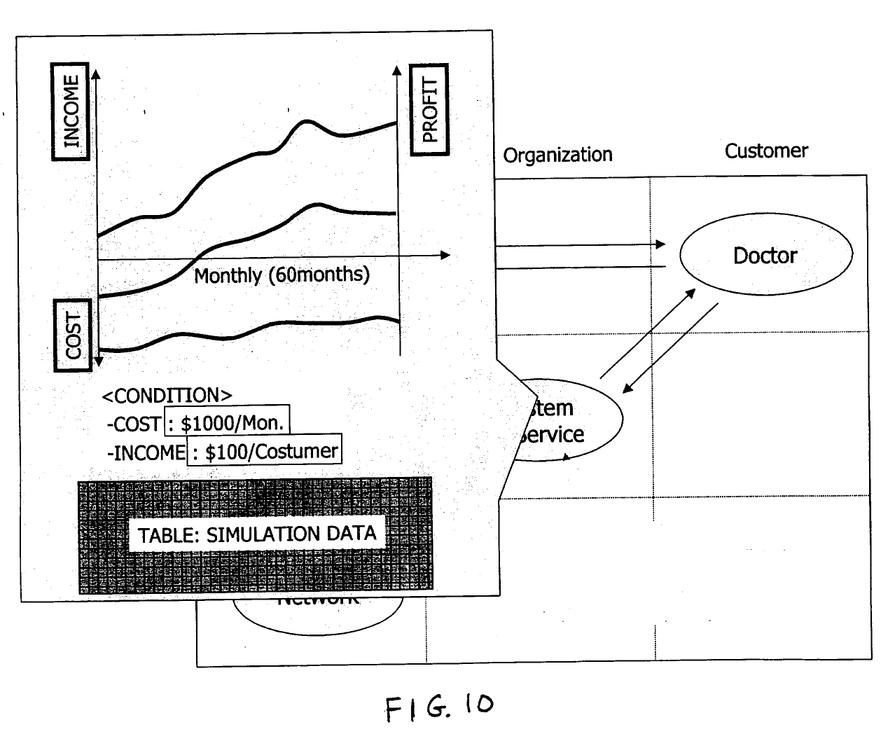

BSRM defines the Graphical Interface as simulation results output as graphs, charts, or dynamic BSRM diagrams. Dynamic BSRM diagrams are diagrams in a format in which the representations of BSEs and SRVs may be decorated with colors or other dynamic properties that change in response to the simulation results stream. The purpose of the change is to convey the state of the simulation model. For example, a profitable BSE may vary in shades of green, while an un-profitable BSE may take on shades of red. An example of graphical simulation output is illustrated in FIG. 10, which shows a graph of income, costs, and revenue associated with a BSE as a function of time.

BSRM defines the Real World Gateway object as a software interface between the BSRM simulation model and real-world business systems. The Gateway object allows this interface to proceed in both the input and output directions. In the output direction, simulation result data from a model run can feed into a real-world system (e.g., a computer-based system used to support business functions such as billing). The purpose of this capability is to allow the BSRM to be use to drive systems for testing and evaluation purposes. In the input direction, the Gateway object allows real-world data from business systems to be coupled to the simulation model to drive Events and Business Processes, for example, to tie the simulation model to a real-world order-entry system.

FIG. 5 illustrates the relationship between the SimSpace object 401, the Simulation Dialog 501, the Event List 502, the Event Object 503, the Business Process object 504, and the Output Manager 510. The Output Manager 510 provides data to the Text-Based Interface 511, the Graphical Interface 512, and the Real World Gateway 513. Finally, the SimSpace writes data to the SIS File 505.

Simulation Tool (BSRMsim)

“BSRMsim” is a simulation tool used to simulate business service relationships according to the system and method of the present invention. BSRMsim is implemented using Visual C++ and is an object-oriented design. Further, BSRMsim is dialog driven and presents interfaces to the user to perform the following functions:

1. Create/Edit a Simulation Space and set parameters for the simulation run,

2. Create/Edit Business Service Entities (BSEs),

3. Create/Edit Service Relationship Vectors (SRVs),

4. Create/Edit Events related to BSEs,

5. View a Summary of BSEs,

6. View a Summary of SRVs,

7. Run the Simulation, and

8. Save the Simulation for later use.

The typical steps to simulate a business service relationship include:

1. Create a simulation space and set the parameters governing the simulation run,

2. Create at least two BSE's and set their parameters,

3. Create at least one SRV and set its parameters,

4. Create Events associated with the BSEs,

5. Run the simulation,

6. View results.

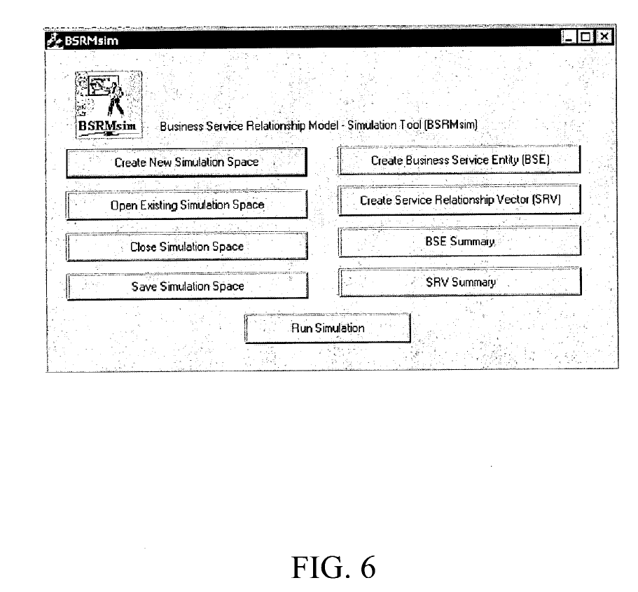

As shown in FIG. 6, the top level dialog box of BSRMsim provides the overall control of the program and access to sub-dialogs used to create objects and run the simulation. The left column of buttons is used for manipulating Simulation Space objects.

The Simulation Space is a software object that serves as a container for the business service relationship being modeled. The object largely comprises a set of lists which are used to keep track of various model components as the model is built, and during execution of the simulation. There are three key lists of objects maintained by within the Simulation Space container. First is the list of BSE objects defined by the user. As the user creates BSEs they are added to the list maintained by the Simulation Space object. Second is the list of SRV objects. As the user creates SRVs they are added to this list. Third is the list of Event objects. Events are the preliminary mechanism for describing dynamic business process actions that are time dependent and are associated with BSEs. As events are created they are added to the event list.

When a model is created and the simulation is running, the software cycles through a loop with each cycle a “clock tick” of the simulation's virtual time. At each cycle, each Event is retrieved from the Event List and the member function Event::Do_Action( ) is executed. In the one embodiment, this action consists of incrementing business process Cost and Revenue variables.

When BSRMsim is running the user is presented with a simple top level dialog, as shown in FIG. 6. The top level dialog buttons and their actions are described below. The Create New Simulation Space dialog allows the user to enter a name for the Simulation Space. This name will be used when the simulation is serialized to a file. It also allows the Simulation Virtual Time to be set. This can be done in two ways:

(1) The user specifies the number of “clock ticks” and the Time Slice. The simulation cycles once for each “clock tick” when running. The Time Slice provides a mapping between the simulation clock and the virtual time in the simulation. Therefore, if the user sets the number of clock ticks to 90 and the Time Slice to “days” then when running the simulation “clock” will tick 90 times and each tick will simulate the passage of one day of virtual time. Current options for the Time Slice are: day, 5-day (work) week, 7-day week, Month and Year.

(2) Alternatively, the user can set a virtual start date and time and a virtual end date and time in standard date/time format. The user must still also select the Time Slice and based on this selection the software will calculate the number of “clock ticks” that will take place when the simulation is run.

When these parameters have been set the user selects the OK button and the dialog closes, returning the user to the top-level dialog. The Simulation Space object is created with the appropriate parameters. However, the space is not saved at this time.

The Open Existing Simulation Space button brings up a standard “file open dialog” that allows the user to select a previously created simulation space. Simulation Spaces are serialized into a file with a “.sis” extension. The name of the file is the same as the name of the simulation space given by the user when it was created.

The Close Simulation Space button closes an existing simulation space (destroys the object). If the space has not been saved it will present a pop-up dialog asking if the user wants to save the space. If the simulation space has been changed it will ask the user if the changes should be saved.

The Save Simulation Space button brings up a standard “file open dialog” that allows the user to specify the directory and change the filename, if desired, for the sis file into which the object will be serialized. It does not “close” the space (i.e., it does not destroy the object).

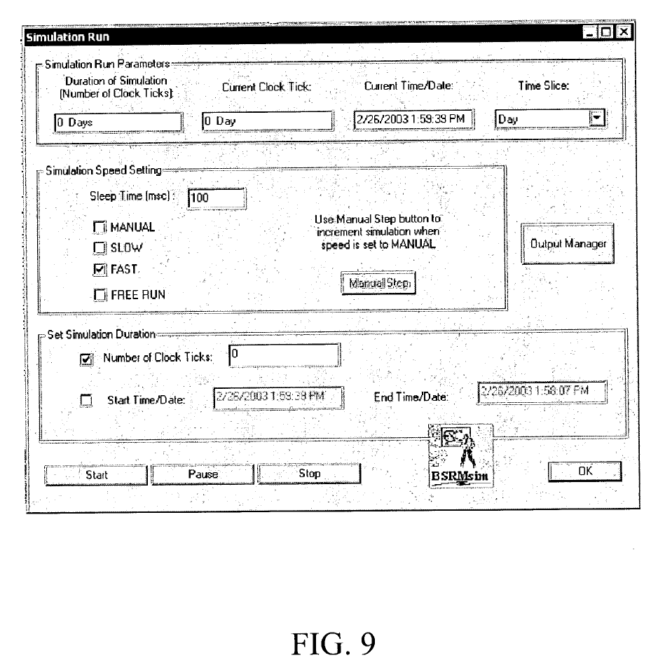

The Run Simulation button brings up a dialog box called “Simulation Run,” shown in FIG. 9. The Simulation Run dialog displays parameters including Number of Clock Ticks, Current Clock Tick, Current Time/Date, and the Time Slice. It also provides a “simulation speed” setting that can be used to select one of four modes for incrementing the clock. The modes are:

(1) Manual—the clock increments under the control of a button selected by the user. The button appears to the right of the speed setting selectors and is disabled unless the manual setting is selected.

(2) Slow—the simulation pauses for 300 ms between cycles. This will slow down the run and is intended for use when there is graphical output that the user may track in real-time. The slower speed will give the user time to comprehend changes.

(3) Fast—the simulation pauses for 100 ms between cycles.

(4) Free Run—the simulation does not pause between cycles but proceeds as fast as instructions can be executed.

This dialog also displays the Simulation settings that were entered when the simulation was created and provides opportunity for the user to change those settings.

The Simulation Run dialog displays three buttons on the lower left that control the run. These are: Start, Pause, and Stop. The Start button sets the parameters to the initial values and starts the clock. Pressing Start again will reset the parameters to the initial value and begin running. Pressing Pause will stop the cycling of the clock but will not reset the parameters. Pressing Pause again will restart the clock. Pressing Stop will stop the clock. After pressing Stop the user must press the Start button to run the simulation.

During the simulation run, the software will open a log file to serialize the event outputs. The events are output into a spreadsheet file in one embodiment. A sample output is shown in Table I below. At each step of the simulation there are two events output for each BSE in the simulation (current cost and current revenue). Currently each simulation run opens a log file with a fixed name (e.g., c:\<simulation name>_log.xls). Therefore, if the user attempts to run more than one simulation at the same time an error message will appear indicating that the log file is busy. The log file name will differ for each differently named simulation. Pressing the OK button closes the dialog. If the simulation is running it will continue to run. Alternatively, output graphs of the simulation output data (e.g., costs, revenue, and profit) may be created by the output manager, as show in FIG. 10.

Creating BSEs

BSEs represent individually identifiable elements of the business model. From the top level dialog (shown in FIG. 6) the “Create Business Service Entity (BSE)” button activates a dialog used to enter information about a new BSE and add it to the Simulation Space.

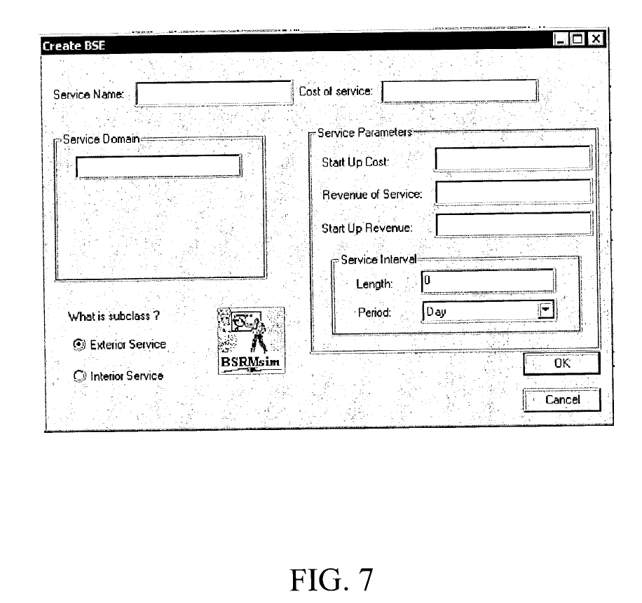

The Create Business Service Entity (BSE) button brings up the “Create BSE” dialog shown in FIG. 7. This dialog provides the user with the capability to enter information about the BSE. This dialog will also result in some additional pop-up dialogs depending on some selections. The current parameters that can be set by the user are the following:

Service Name—Allows the user to enter the name of the BSE.

Cost of Service—Allow the user to enter a cost associated with the service. This is a recurring cost of providing the service.

Service Domain—This allows the user to select from one of several Service Domains. Alternatively, the user can assign the BSE to a service domain with an arbitrary name.

Start-up Cost—A non-recurring cost associated with the service. This is an initial (one-time) cost associated with offering the service.

Revenue of Service—This is the recurring revenue earn by providing the service.

Start-up Revenue—This is a possible one-time influx of revenue associated with starting the service (e.g., initiation fee, etc.)

Service Interval—This parameter is specified by a Length and a Period type (same format as Time Slice).

Subclass—This selector allows the user to determine what type of BSE this instance will be. There are two types: Interior Service and Exterior Service. Interior BSEs are entities that are part of the organization from whose perspective the business process is modeled. For example, this could be a department within a company. An exterior entity is not part of the organization from whose perspective the business process is modeled. For example, an external (outsourced) function is an Exterior BSE. The selection here may generate additional pop-up menus.

When the subclass for the BSE is selected, an additional pop-up dialog will appear asking for information which is specific to the two different subclasses. For Interior BSEs the dialog simply asks for a department name. For Exterior BSEs (which represent external or outsourced entities) the dialog asks for the name of the service provider and a contract number.

The BSE Summary button, shown in FIG. 6, brings up a List Box control that shows a summary of the BSEs that have been created. It allows the user to sort the BSEs by various categories. By selecting the BSE with the cursor and right clicking the user will get a pop up box to select one of four functions: Rename, Edit, Delete, Copy.

Rename brings up a simple pop-up dialog allowing the user to change the name of the BSE.

Edit brings a dialog identical to the dialog used to create the BSE, allowing the user to change any parameter and even the sub-class of the BSE.

Delete will bring up an “are you sure?” dialog and allow the user to commit to deleting the BSE. When a BSE is deleted, the software will automatically delete all SRVs (relationships) which include this BSE.

Copy will duplicate the BSE object and give the new object whose name is the same as the original but with the prefix “Copy of.” This gives the user the capability to rapidly add BSEs that are similar.

Creating SRVs

SRVs represent relationships between BSEs in the business model. From the top-level dialog (shown in FIG. 6) the “Create Service Relationship Vector (SRV)” button activates a dialog used to enter information about a new SRV and add it to the Simulation Space.

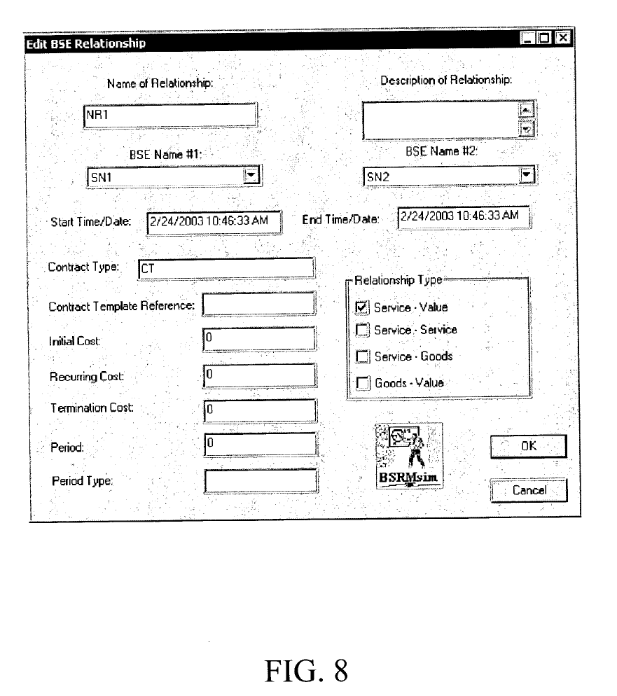

The Create Service Relationship Vector (SRV) button brings up the “Edit BSE Relationship” dialog shown in FIG. 8. This dialog provides the user with the capability to enter information about the SRV. This dialog will also result in some additional pop-up dialogs depending on some selections. The current parameters that can be set by the user are the following:

Name of Relationship—Allows the user to enter the name for the SRV.

Description of Relationship—A free text field allowing a description of the relationship.

BSE Name #1—Allows the user select the first BSE from a pull down list of existing BSEs. Currently, relationships are between pairs of BSEs and must be created after the BSEs have been created.

BSE Name #2—Allows the user select the second BSE from a pull down list of existing BSEs.

Start Time/Date—This is the virtual time at which the relationship starts.

End Time/Date—This is the virtual time at which the relationship ends.

Contract Type—This is a text descriptor for later reference.

Contract Template Reference—this is a text descriptor for later reference.

Initial Cost—This specifies an initial cost of the relationship.

Recurring Cost—This specifies a recurring cost of the relationship.

Termination Cost—This specifies a cost associated with terminating the service relationship.

Period—This specifies the period associated with costs (Length).

Period Type—This specifies the Time Slice of the period.

Relationship Type—This specifies the sub-class of the Service Relationship Vector.

There are four subclasses: Service-Value, Service-Service, Service-Goods and Goods-Value. The selection of the subclass will result in a pop-up dialog specific to the subclass for additional information.

When the Relationship Type is selected a pop-up dialog will appear that queries the user for additional information specific to the type of relationship. In one embodiment, the dialogs ask for the following information:

(1) Service-Value SRV—The dialog asks for a Service type, an interval associated with the service, a value, and the billing period associated with the value. It can represent relationships between two interior entities, and interior and exterior entity, and between two exterior entities. It represents a provision of services for payment.

(2) Service-Service SRV—The dialog asks for Service type and interval for each side of the relationship, along with an accounting period. This service is expected to be used mostly in relationships between entities within the same organization and represents an exchange of services.

(3) Service-Goods SRV—This dialog asks for Service type and interval, Goods type and associated PO. It represents an exchange of services for goods.

(4) Goods-Value SRV—This dialog asks for PO number and goods type. It represents the simple purchasing of goods.

The SRV Summary button, shown in FIG. 6, brings up a List Box control that shows a summary of the SRVs that have been created. It allows the user to sort the SRVs by various categories. By selecting the SRV with the cursor and right clicking the user will get a pop up box to select one of four functions: Rename, Edit, Delete, and Copy.

Rename brings up a simple pop-up dialog allowing the user to change the name of the BSE.

Edit brings a dialog identical to the dialog used to create the BSE, allowing the user to change any parameter and even the sub-class of the BSE.

Delete will bring up an “are you sure?” dialog and allow the user to commit to deleting the BSE.

Copy will duplicate the BSE object and give the new object whose name is the same as the original but with the prefix “Copy of.” This gives the user the capability to rapidly add BSEs that are similar.

The method and system of the present invention conveniently may be implemented using a conventional general purpose computer or microprocessor programmed according to the teachings of the present invention, as will be apparent to those skilled in the computer art. Appropriate software can readily be prepared by programmers of ordinary skill based on the teachings of the present disclosure, as will be apparent to those skilled in the software art.

In a particular preferred embodiment, the BSRM simulation was programmed in software using the Visual C++ programming language. Of course, other suitable programming languages operating may be chosen to implement the invention.

A general purpose computer may implement the method of the present invention, wherein the computer housing houses a motherboard which contains a CPU (central processing unit), memory such as DRAM (dynamic random access memory), ROM (read only memory), EPROM (erasable programmable read only memory), EEPROM (electrically erasable programmable read only memory), SRAM (static random access memory), SDRAM (synchronous dynamic random access memory), and Flash RAM (random access memory), and other optical special purpose logic devices such as ASICs (application specific integrated circuits) or configurable logic devices such GAL (generic array logic) and reprogrammable FPGAs (field programmable gate arrays).

The computer may also include plural input devices, (e.g., keyboard and mouse), and a display card for controlling a monitor. Additionally, the computer may include a floppy disk drive; other removable media devices (e.g. compact disc, tape, and removable magneto optical media); and a hard disk or other fixed high density media drives, connected using an appropriate device bus such as a SCSI (small computer system interface) bus, an Enhanced IDE (integrated drive electronics) bus, or an Ultra DMA (direct memory access) bus. The computer may also include a compact disc reader, a compact disc reader/writer unit, or a compact disc jukebox, which may be connected to the same device bus or to another device bus.

As stated above, the system includes at least one computer readable medium. Examples of computer readable media include compact discs, hard disks, floppy disks, tape, magneto optical disks, PROMs (e.g., EPROM, EEPROM, Flash EPROM), DRAM, SRAM, SDRAM, etc. Stored on any one or on a combination of computer readable media, the present invention includes software for controlling both the hardware of the computer and for enabling the computer to interact with a human user. Such software may include, but is not limited to, device drivers, operating systems and user applications, such as development tools.

Such computer readable media further includes the computer program product of the present invention for performing the inventive method herein disclosed. The computer code devices of the present invention can be any interpreted or executable code mechanism, including but not limited to, scripts, interpreters, dynamic link libraries, Java classes, and complete executable programs.

In addition, the BSRM model of the present invention can be used for other types of simulations related to radiology imaging by creating new types of BSE subclasses or adding additional types of objects. For example, a large-scale PACS design or geographically distributed teleradiology system may be simulated with BSRM. For a PACS system, one can define modalities, imaging equipment, and archives as BSEs, and define the relationship between them as SRVs. Of course, such an implementation would require the creation of new SRV subclasses that capture appropriate technical detail and parameters, which could easily be accomplished by one of ordinary skill in the art.

The present invention has been described in terms of preferred embodiments solely for the purpose of illustration. Persons skilled in the art will recognize from this description that the invention is not limited to the embodiments described, but may be practiced with modifications and alterations limited only by the spirit and scope of the appended claims.

TABLE I
Simulation Output Example
Name of Simulation Space: ARC2
Number of Clock Tick: 36 Months
Time Slice: Month

| Current Clock Tick | Event Name | Action Sum |
|---|---|---|
| 1 Month | archiveserviceCost | 18500 |
| 1 Month | archiveserviceRevenue | 5000 |
| 1 Month | RadiologyreadingCost | 19000 |
| 1 Month | RadiologyreadingRevenue | 10000 |
| 1 Month | Customer1Cost | 34000 |
| 1 Month | Customer1Revenue | 30000 |
| 1 Month | Customer2Cost | 1000 |
| 1 Month | Customer2Revenue | 1000 |
| 1 Month | Customer3Cost | 2000 |
| 1 Month | Customer3Revenue | 1000 |
| 1 Month | Customer4Cost | 2000 |
| 1 Month | Customer4Revenue | 1000 |
| 1 Month | SPCost | 1500 |
| 1 Month | ISPRevenue | 2000 |
| 1 Month | StorageSupportCost | 4800 |
| 1 Month | StorageSupportRevenue | 2000 |
| 2 Month | archiveserviceCost | 17000 |
| 2 Month | archiveserviceRevenue | 10000 |
| 2 Month | RadiologyreadingCost | 18000 |
| 2 Month | RadiologyreadingRevenue | 20000 |
| 2 Month | Customer1Cost | 70000 |
| 2 Month | Customer1Revenue | 60000 |
| 2 Month | Customer2Cost | 0 |
| 2 Month | Customer2Revenue | 2000 |
| 2 Month | Customer3Cost | 6000 |
| 2 Month | Customer3Revenue | 2000 |
| 2 Month | Customer4Cost | 4000 |
| 2 Month | Customer4Revenue | 2000 |
| 2 Month | ISPCost | 1000 |
| 2 Month | ISPRevenue | 4000 |
| 2 Month | StorageSupportCost | 4600 |
| 2 Month | StorageSupportRevenue | 4000 |

<Intermediate entries not shown>

| | | |
|---|---|---|
| 35 Month | archiveserviceCost | 32500 |
| 35 Month | archiveserviceRevenue | 175000 |
| 35 Month | RadiologyreadingCost | 15000 |
| 35 Month | RadiologyreadingRevenue | 350000 |
| 35 Month | Customer1Cost | 258000 |
| 35 Month | Customer1Revenue | 1050000 |
| 35 Month | Customer2Cost | 33000 |
| 35 Month | Customer2Revenue | 35000 |
| 35 Month | Customer3Cost | 138000 |
| 35 Month | Customer3Revenue | 35000 |
| 35 Month | Customer4Cost | 70000 |
| 35 Month | Customer4Revenue | 35000 |
| 35 Month | ISPCost | 15500 |
| 35 Month | ISPRevenue | 70000 |
| 35 Month | StorageSupportCost | 2000 |
| 35 Month | StorageSupportRevenue | 70000 |
| 36 Month | archiveserviceCost | 34000 |
| 36 Month | archiveserviceRevenue | 180000 |
| 36 Month | RadiologyreadingCost | 16000 |
| 36 Month | RadiologyreadingRevenue | 360000 |
| 36 Month | Customer1Cost | 1294000 |
| 36 Month | Customer1Revenue | 1080000 |
| 36 Month | Customer2Cost | 34000 |
| 36 Month | Customer2Revenue | 36000 |
| 36 Month | Customer3Cost | 142000 |
| 36 Month | Customer3Revenue | 36000 |
| 36 Month | Customer4Cost | 72000 |
| 36 Month | Customer4Revenue | 36000 |
| 36 Month | ISPCost | 16000 |
| 36 Month | ISPRevenue | 72000 |
| 36 Month | StorageSupportCost | 2200 |
| 36 Month | StorageSupportRevenue | 72000 |

1. A method of evaluating a business service relationship model for a business organization, the business service relationship model comprising a plurality of business service entities (BSEs) and at least one service relationship vector (SRV), each SRV of the at least one SRV defining a business relationship between two BSEs in the plurality of BSEs, the method comprising:
storing respective attribute information for the plurality of BSEs;
storing respective attribute information for the at least one SRV;
simulating the business service relationship model over a simulation time period based on the stored BSE attribute information and the stored SRV attribute information; and
displaying results of the simulating step in order to evaluate the business service relationship model.

2. The method of claim 1, further comprising:
storing respective attribute information for at least one service domain (SD);
defining at least one business process (BP) associated with a respective BSE in the plurality of BSEs; and
storing respective attribute information for the at least one BP.

3. The method of claim 2, wherein the simulating step comprises:
simulating the business service relationship model over a simulation time period using the stored BSE attribute information, the stored SRV attribute information, the stored SD attribute information, and the stored BP attribute information.

4. The method of claim 2, wherein the defining step comprises:
setting the respective attribute information of the at least one BP to include a process module that represents business intelligence of the respective BSE.

5. The method of claim 4, wherein the setting step comprises one of:
setting the process module to be a mathematical function that processes the stored attribute information of the respective BSE and the stored attribute information of at least one SRV associated with the respective BSE; and
setting the process module to be a computer program code comprising a sequence of logical steps that operate on the stored attribute information of the respective BSE and the stored attribute information of the at least one SRV associated with the respective BSE.

6. The method of claim 2, wherein the step of storing respective attribute information for the at least one SD comprises:
assigning a domain name to each service domain of the at least one SD.

7. The method of claim 1, wherein the displaying step comprises:
displaying results of the simulating step in a format under control of an output manager in order to evaluate the business service relationship model.

8. The method of claim 1, wherein the step of storing respective attribute information for the plurality of BSEs comprises:
storing respective service domain assignments for each of the plurality of BSEs.

9. The method of claim 1, wherein the step of storing respective attribute information for the plurality of BSEs comprises:
storing respective attribute information associated with providing one of a good and a service, including start-up cost, revenue of service, start-up revenue, service interval length, and service period, for each of the plurality of BSEs.

10. The method of claim 1, wherein the step of storing respective attribute information for the plurality of BSEs comprises:
storing, for each BSE in the plurality of BSEs, respective attribute information indicating whether each BSE is an interior business entity of the business organization.

11. The method of claim 1, wherein the step of storing respective attribute information for the at least one SRV comprises:
identifying a respective pair of BSEs in the plurality of BSEs for each SRV in the at least one SRV; and
storing, for each SRV in the at least one SRV, respective attribute information indicating one of a service-value, service-service, goods-value, and goods-service business relationship between the identified respective pair of BSEs.

12. The method of claim 1, wherein the step of storing respective attribute information for the at least one SRV comprises:
storing respective attribute information associated with a contract for one of goods and a service, including contract type, contract start date, contract end date, initial cost, termination cost, recurring cost, initial revenue, contract period, and contract period type.

13. The method of claim 1, wherein the simulating step comprises:
storing simulation parameters including a simulation start time, a simulation end time, the simulation time period, a simulation update interval, and a simulation output method; and
calculating updates to cost and revenue attributes of each of the plurality of BSEs for at least one simulation update interval.

14. The method of claim 13, wherein the displaying step comprises:
providing information to an end-user including a value of the business service relationship model by sending the results of the simulating step to an output manager, the results being formatted by the output manager according to the stored simulation output method.

15. The method of claim 14, further comprising:
creating a mapping between the stored BSE attribute information, the stored SRV attribute information, the stored BP attribute information, and corresponding data variables in an external real-world system;
directing the output manager to send the results of the simulating step to the external real-world system through a real-world gateway during the simulation time period;
receiving input information from the external real-world system through the real-world gateway during the simulation time period; and
directing the input information to the at least one BP using the mapping.

16. A system configured to evaluate a business service relationship model for a business organization by performing the steps recited in any one of claims 1-15.

17. A computer program product configured to store plural computer program instructions which, when executed by a computer, cause the computer perform the steps recited in any one of claims 1-15.
